(19) United States
(12) Patent Application Publication
(10) Pub. No.: US 2017/0078222 A1
(43) Pub. Date: Mar. 16, 2017

(54) CONTROL DEVICE AND METHOD OF CONTROLLING A PLURALITY OF NETWORK SWITCHES

(71) Applicant: FUJITSU LIMITED, Kawasaki-shi (JP)

(72) Inventors: Shinji Yamashita, Kawasaki (JP); AKIKO YAMADA, Kawasaki (JP); Kenji Hikichi, Kawasaki (JP); Keiichi Nakatsugawa, Shinagawa (JP); TOSHIO SOUMIYA, Yokohama (JP)

(73) Assignee: FUJITSU LIMITED, Kawasaki-shi (JP)

(21) Appl. No.: 15/227,338

(22) Filed: Aug. 3, 2016

(30) Foreign Application Priority Data
Sep. 14, 2015 (JP) 2015-180862

(51) Int. Cl. H04L 12/931; H04L 12/26; H04L 12/721; H04L 12/947

(52) U.S. Cl. CPC H04L 49/50; H04L 49/25; H04L 43/16; H04L 45/38

(57) ABSTRACT

A control device configured to control a plurality of network switches provided in a plurality of communication paths including a first communication path and a second communication path, the control device includes a memory, and a processor coupled to the memory and configured to control the plurality of network switches so that one or more data flows pass through the first communication path, monitor a load of the control device, detect that a failure occurs in the first communication path, and determine, based on a number of the one or more data flows and the load of the control device, a path selecting method of selecting the second communication path as an alternative communication path through which the data flows are to be transmitted.

### CROSS-REFERENCE TO RELATED APPLICATION

This application is based upon and claims the benefit of priority of the prior Japanese Patent Application No. 2015-180862, filed on Sep. 14, 2015, the entire contents of which are incorporated herein by reference.

### FIELD

A technology described in the present specification is related to a control device and a method of controlling a plurality of network switches.

### BACKGROUND

In recent years, computing resources progressively become virtualized, and in association with the possibility of deploying, in a network, virtual computers on demand, software defined networking (SDN) attracts attention.

The SDN is a technology for enabling a network to be set or modified on demand by using software. Applying the SDN to a network in which one controller manages and controls network switches is considered.

As one of potential candidates of a communication protocol able to realize the SDN in such as network, there is an open flow (OF) protocol. By communicating with individual network switches by use of the OF protocol, a controller is able to manage and control the individual network switches.

Note that a controller to support the OF protocol is called an OF controller (OFC) in some cases. In addition, a network switch to support the OF protocol is called an OF switch (OF-SW) in some cases. As documents of the related art, there are Japanese Laid-open Patent Publication No. 2014-138244, International Publication Pamphlet No. WO 2011/043379, and International Publication Pamphlet No. WO 2011/043363.

### SUMMARY

According to an aspect of the invention, a control device configured to control a plurality of network switches provided in a plurality of communication paths including a first communication path and a second communication path, the control device includes a memory, and a processor coupled to the memory and configured to control the plurality of network switches so that one or more data flows pass through the first communication path, monitor a load of the control device, detect that a failure occurs in the first communication path, and determine, based on a number of the one or more data flows and the load of the control device, a path selecting method of selecting the second communication path as an alternative communication path through which the data flows are to be transmitted.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a communication system according to an embodiment.

FIG. 2 is a diagram illustrating an example of a flow table in an OF switch (#1) exemplified in FIG. 1.

FIG. 3 is a diagram illustrating an example of a flow table in an OF switch (#3) exemplified in FIG. 1.

FIG. 4 is a diagram for explaining an example of failure recovery processing in the communication system exemplified in FIG. 1.

FIG. 5A is a diagram illustrating an example of a temporal flow of failure recovery processing based on a “proactive method”, and FIG. 5B is a diagram illustrating an example of a temporal flow of failure recovery processing based on a “reactive method”.

FIG. 6 is a diagram illustrating an example of data used for estimating an impact of path calculation of the number N of flows on a CPU usage rate in an open flow controller (OFC) exemplified in FIG. 1.

FIG. 7 is a pattern diagram for explaining an example of adaptively selecting a failure recovery method in accordance with the number of flows serving as failure recovery targets and the CPU usage rate in the OFC exemplified in FIG. 1.

FIG. 8 is a block diagram illustrating an example of a functional configuration of the OFC in exemplified in FIG. 1.

FIG. 9 is a diagram illustrating an example of determination criteria used for selecting a failure recovery method by a failure recovery method selection unit exemplified in FIG. 8.

FIG. 10 is a flowchart illustrating an example of an operation of the OFC exemplified in FIG. 1 and FIG. 8.

FIG. 11 is a block diagram illustrating an example of a hardware configuration of the OFC exemplified in FIG. 1 and FIG. 8.

FIG. 12 is a block diagram illustrating an example of functional configurations of the OF switches exemplified in FIG. 1.

FIG. 13 is a block diagram illustrating an example of a hardware configuration of the OF switch exemplified in FIG. 1 and FIG. 12.

FIG. 14 is a diagram for explaining a first example of a modification.

FIG. 15 is a flowchart illustrating an example of an operation of an OFC of the first example of a modification.

FIG. 16 is a diagram for explaining a second example of a modification.

FIG. 17 is a flowchart illustrating an example of an operation of an OFC of the second example of a modification.

FIG. 18 is a diagram illustrating an example of a flow table managed by an OFC according to a third example of a modification.

FIG. 19 is a pattern diagram for explaining an example of selection of a failure recovery method according to a fourth example of a modification.

FIG. 20 is a flowchart illustrating an example of an operation of an OFC according to the fourth example of a modification.

FIG. 21 is a pattern diagram for explaining an example of selection of a failure recovery method according to a fifth example of a modification.

FIG. 22 is a flowchart illustrating an example of an operation of an OFC according to the fifth example of a modification.

FIG. 23 is a flowchart illustrating an example of an operation of an OFC according to a sixth example of a modification.

### DESCRIPTION OF EMBODIMENTS

In a case where a path failure occurs in an OF network including an OFC and OF switches, the OFC performs processing (may be called “failure recovery processing”) for resetting, in an OF switch located in a new path, a data flow of a path in which the failure occurs.

However, depending on the number of data flows serving as failure recovery targets, the OFC is overloaded, and it takes a long time to recover from the failure in some cases. In addition, while the load of the OFC has a margin, effective utilization of resources available for path resetting processing is not achieved, and the failure recovery is extended for a long period of time.

Hereinafter, embodiments will be described with reference to drawings. In this regard, however, the embodiments described later are just exemplified, and there is no intention to exclude various modifications and various applications of the technology, unspecified hereinafter. In addition, various kinds of exemplary embodiments to be described later may be arbitrarily combined and implemented. Note that, unless otherwise noted, a portion to which the same symbol is assigned in drawings used in the following embodiments indicates the same portion or a similar one.

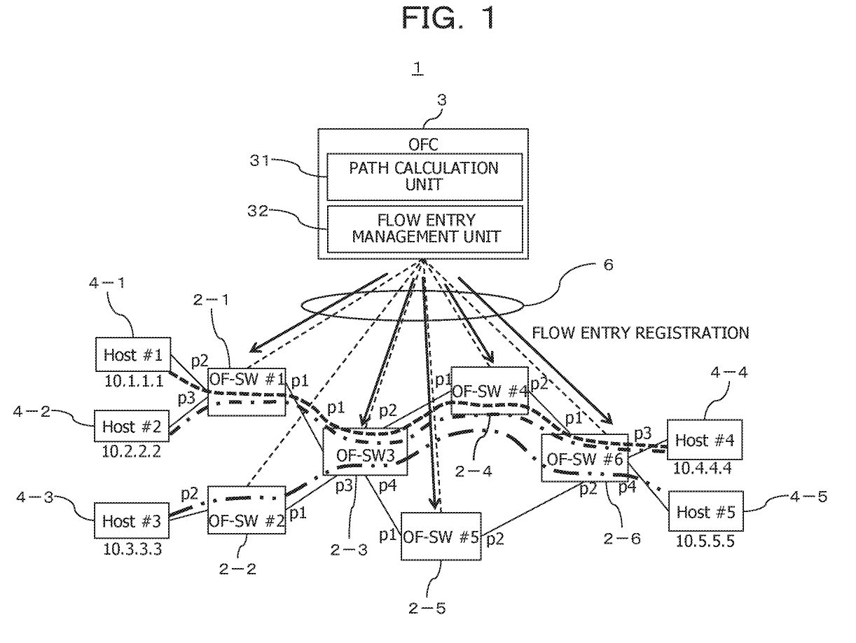

FIG. 1 is a block diagram illustrating an example of a configuration of a communication system according to an embodiment. As illustrated in FIG. 1, a communication system 1 (may be conveniently called a “network 1”) may exemplarily include network switches 2-1 to 2-n (#1 to #n), which each serve as an example of a communication device (may be called a “network device”), and a controller 3.

Note that “n” is an integer greater than or equal to 2 and n=6 is satisfied in the example of FIG. 1. In a case where the network switch 2-i (i=one of 1 to n) does not have to be differentiated, the network switch 2-i is abbreviated to a “network switch 2” or simply abbreviated to a “switch 2” in some cases. The network switches 2 may be each called an element of the network 1 (NE).

Each of the switches 2 may exemplarily support an open flow protocol (OFP). The OFP is an example of a communication protocol. The switches 2 to support the OFP may be each called an “OF switch (OF-SW) 2”.

As exemplified in FIG. 1, the OF switches 2 may be coupled in mesh form, thereby forming a mesh network. In this regard, however, the form (may be conveniently called a “topology”) of a network (may be conveniently called an “OF network”) formed by the OF switches 2 is not limited to the mesh network.

In the example of FIG. 1, a port “p1” of the OF switch #1 is coupled to a port “p1” of the OF switch #3, and a port “p1” of the OF switch #2 is coupled to a port “p3” of the OF switch #3.

In addition, a port “p2” of the OF switch #3 is coupled to a port “p1” of the OF switch #4, and a port “p4” of the OF switch #3 is coupled to a port “p1” of the OF switch #5.

Furthermore, a port “p2” of the OF switch #4 is coupled to a port “p1” of the OF switch #6, and a port “p2” of the OF switch #5 is coupled to a port “p2” of the OF switch #6.

Note that a port “px” (x is a natural number and x=one of 1 to 4 is satisfied in the example of FIG. 1) of an OF switch #i indicates a port number and is an example of information able to identify a port provided in the OF switch #i.

One or more host machines 4-j (j is one of 1 to m: m is an integer greater than or equal to 2) (#j) may be coupled to the OF switch 2 located around an edge of the OF network. The host machine 4-j is an example of a “communication device”.

As illustrated in, for example, FIG. 1, the two host machines 4-1 and 4-2 may be coupled to ports “p2” and “p3”, respectively, of the OF switch 2-1. The one host machine 4-3 may be coupled to the OF switch 2-2. In addition, the two host machines 4-4 and 4-5 may be coupled to ports “p3” and “p4”, respectively, of the OF switch 2-6.

The host machines 4-j are able to communicate with each other via the OF network. In other words, in the OF network, data transmitted by one of the host machines 4-j is routed through one or more of the OF switches 2 and is transferred (may be called “forwarding”) to the host machine 4-k serving as a communication partner. Note that “k” is one of 1 to m and is an integer satisfying k≠j.

For example, the host machines 4-1 and 4-2 are able to communicate, as illustrated by a dotted line and a dashed-dotted line, respectively, in FIG. 1, with the host machine 4-4 via a route that goes through the OF switches #1, #3, #4, and #6.

In addition, as illustrated by a two-dot chain line in FIG. 1, the host machine 4-3 is able to communicate with the host machine 4-5 via a route that goes through the OF switches #2, #3, #4, and #6.

Note that in the example of FIG. 1, as examples of pieces of address information, “10.1.1.1”, “10.2.2.2”, “10.3.3.3”, “10.4.4.4”, and “10.5.5.5” are assigned to the host machines 4-1 to 4-5, respectively.

In addition, in what follows, in a case where the host machine 4-j does not have to be differentiated, the host machine 4-j is abbreviated to a “host machine 4” in some cases. In addition, the host machine 4 may be conveniently abbreviated to a “host 4”.

The controller 3 is exemplarily coupled to the OF switches 2 to form the OF network, via a control network 6 so as to be communicatable therewith, and is able to intensively manage and control the individual OF switches 2.

Communication related to the management and control, based on the controller 3, of the individual OF switches 2 may be conveniently called “control communication” or “communication in a control plane”. The “communication in a control plane” may be conveniently abbreviated to “CP communication”. A signal and a message, used for the “CP communication”, may be called a “control signal” and a “control message”, respectively. The OF protocol may be used for the “CP communication”.

The controller 3 able to perform the CP communication by using the OF protocol may be called an “open flow controller (OFC) 3”. A transmission control protocol (TCP) or a transport layer security (TLS) may be exemplarily applied to the control network 6 to couple the OFC 3 and the individual OF switches 2. In other words, “sessions” of the TCP or the TLS may be set and established between the OFC 3 and the individual OF switches 2.

Communication between the OF switches 2 is exemplarily transfer of data in a data plane and may be called a “data flow” or may be simply called a “flow”. Data transferred by using the “flow” is an example of a signal and may be exemplarily packet data. The packet data may be simply abbreviated to a “packet”.

It may be thought that the OFC 3 configures the CP and the OF switches 2 each configure the data plane (DP). In other words, by using the OF protocol for the CP communication between the OF switches 2 and the OFC 3, it is possible to separate the CP and the DP.

Note that some or all of the OFC 3 and the OF switches 2 and some or all of the hosts 4 may be realized by physical machines such as physical computers or servers or may be realized by virtual machines.

The OFC 3 may manage and control flows between the OF switches 2 in an integrated manner. For example, the OFC 3 may manage and control, in a concentrated manner or in an integrated manner, entries of flow tables stored by the OF switches 2.

In order to control flows between the OF switches 2, the OFC 3 may detect topology information of the OF network. The topology information is an example of information for making identifiable a coupling relationship between the OF switches 2 in the OF network. Based on the topology information, path calculation and so forth regarding the OF network may be implemented in the OFC 3.

Based on, for example, the topology information of the OF network, the OFC 3 is able to realize advanced traffic engineering such as path control able to achieve low power consumption of the entire OF network.

In addition, a unit of control based on the OFC 3 is defined as a “flow”, and a flow of data is expressed by a “flow” in each of combinations of networks each having an existing layer structure, thereby enabling layer-independent communication control.

Packet transfer between the OF switches 2 is exemplarily implemented by the “flow tables” stored in the respective OF switches 2. Flow entries may be registered and stored in each of the “flow tables”.

In each of the flow entries, “match rules” and “actions” for the “match rules” may be specified in flow units of packets to flow between the OF switches 2. As the “actions”, transfer (forwarding) of a reception packet to a specific output port, a rewrite of a specific header field of a reception packet, packet discarding, and so for may be specified.

Upon a packet being input to one of the OF switches 2, the corresponding OF switch 2 references the corresponding “flow table” and performs an “action” matched with a “rule” registered in the corresponding “flow table”.

In a case where a “rule” corresponding to the input packet is unregistered in the corresponding “flow table”, in other words, in a case where a reception packet is an unknown packet in a relationship with the corresponding “flow table”, the corresponding OF switch 2 may make an inquiry about the corresponding “rule” while addressing to the OFC 3.

A control message called a “packet-in message” may be used for the relevant inquiry. Note that “packet-in message” may be simply called a “packet-in”. The packet-in is an example of a signal to be addressed to the OFC 3 and transmitted by the corresponding OF switch 2 in response to reception of a packet (unknown packet) of a data flow unregistered in the corresponding flow table.

Upon receiving the packet-in from the corresponding OF switch 2, the OFC 3 may transmit, to the OF switch 2 serving as a transmission source of the packet-in, a “rule” corresponding to the unknown packet included in the relevant packet-in.

A control message called a flow modification (FlowMod) message may be used for transmitting the corresponding “rule”. The flow modification message is an example of a signal to be addressed to the corresponding OF switch 2 and transmitted by the OFC 3.

In response to reception of the flow modification message from the OFC 3, the corresponding OF switch 2 sets and registers, in the corresponding “flow table”, the corresponding “rule” set in the relevant message.

As described above, the OFC 3 is able to determine a path of a flow corresponding to the packet-in and to set and register a flow entry in the corresponding “flow table” for the corresponding OF switch 2 located in the determined path.

Therefore, as exemplified in FIG. 1, the OFC 3 may include a path calculation unit 31 and a flow entry management unit 32. The flow entry management unit 32 may be restated as a “flow table management unit 32”.

Path calculation of a flow corresponding to the above-mentioned packet-in may be implemented by the path calculation unit 31. In addition, the above-mentioned setting and registration of a flow entry in the “flow table” of each of the OF switches 2 may be implemented by the flow entry management unit 32.

Note that since, by using the “packet-in”, the OFC 3 is able to be notified of the unknown packet received in the DP by the corresponding OF switch 2, packets based on various communication protocols are allowed to be transferred in the DP between the OF switches 2. In addition, in the OFP, a “packet-out message” (may be conveniently abbreviated to a “packet-out”) is specified with respect to the “packet-in”.

The “packet-out” is used by the OFC 3 to instruct to deliver a packet to the DP between the OF switches 2. By using the packet-out, the OF switches 2 are able to deliver packets based on various communication protocols.

In a case of providing, for example, a link layer discovery protocol (LLDP) function in the DP, the OFC 3 may address, to the corresponding OF switch 2, and transmit the packet-out including an LLDP packet.

In response to reception of the relevant packet-out, the corresponding OF switch 2 is able to deliver, to the DP, LLDP packets from ports (some or all thereof may be used) specified by the packet-out.

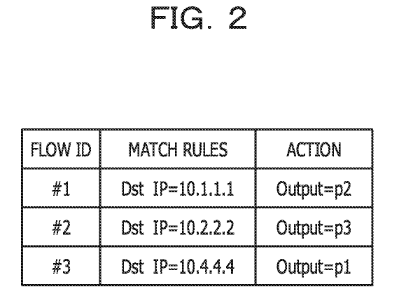

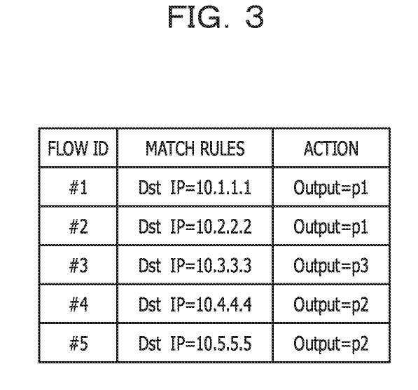

FIG. 2 illustrates an example of the flow table in the OF switch (#1) exemplified in FIG. 1, and FIG. 3 illustrates an example of the flow table in the OF switch (#3) exemplified in FIG. 1. Note that, as exemplified in FIG. 1, FIG. 2 and FIG. 3 each illustrate an example of the corresponding flow table in a case where communication is individually performed between the hosts #1 and #4, between the hosts #2 and #4, and between the hosts #3 and #5.

As exemplified in FIG. 2, flow entries corresponding to respective three flow identifiers (ID)=#1 to #3 are registered in the flow table of the OF switch #1. In each of the flow entries, destination address information is described as a “match rule”, and an output port number is described as an “action” corresponding to the “match rule”.

Upon receiving, by use of a flow, a packet including the address information “10.1.1.1” of the host #1 as the destination address information, the flow being identified by, for example, the flow ID #1, the OF switch #1 outputs the relevant packet to the output port “p2”.

Since the output port “p2” of the OF switch #1 is coupled to the host #1, the relevant packet is transferred to the host #1.

In addition, upon receiving, by use of a flow, a packet including the address information “10.2.2.2” of the host #2 as the destination address information, the flow being identified by, for example, the flow ID #2, the OF switch #1 outputs the relevant packet to the output port “p3”.

Since the output port “p3” of the OF switch #1 is coupled to the host #2, the relevant packet is transferred to the host #2.

In the same way, upon receiving, by use of a flow, a packet including the address information “10.4.4.4” of the host #4 as the destination address information, the flow being identified by, for example, the flow ID #3, the OF switch #1 outputs the relevant packet to the output port “p1”.

Since the output port “p1” of the OF switch #1 is coupled to the port “p1” of the OF switch #3 located in a path toward the host #4, the relevant packet is transferred to the OF switch #3.

On the other hand, as exemplified in FIG. 3, flow entries corresponding to respective five flow IDs=#1 to #5 are registered in the flow table of the OF switch #3. In the same way as in the flow table of the OF switch #1, in each of the flow entries, destination address information is described as a “match rule”, and an output port number is described as an “action” corresponding to the “match rule”.

Upon receiving, by use of a flow, a packet including the address information “10.1.1.1” of the host #1 as the destination address information, the flow being identified by, for example, the flow ID #1, the OF switch #3 outputs the relevant packet to the output port “p1”.

Since the output port “p1” is coupled to the port “p1” of the OF switch #1 to which the host #1 is coupled, the relevant packet is transferred to the OF switch #1. As exemplified in FIG. 2, in the OF switch #1, a packet including the address information “10.1.1.1” is output to the output port “p2”. Therefore, the relevant packet is transferred to the host #1.

In addition, upon receiving, by use of a flow, a packet including the address information “10.2.2.2” of the host #2 as the destination address information, the flow being identified by, for example, the flow ID #2, the OF switch #3 outputs the relevant packet to the output port “p1”.

Since the output port “p1” of the OF switch #3 is coupled to the port “p1” of the OF switch #1 to which the host #2 is coupled, the relevant packet is transferred to the OF switch #1. As exemplified in FIG. 2, in the OF switch #1, a packet including the address information “10.2.2.2” is output to the output port “p3”. Therefore, the relevant packet is transferred to the host #2.

In the same way, upon receiving, by use of a flow, a packet including the address information “10.3.3.3” of the host #3 as the destination address information, the flow being identified by, for example, the flow ID #3, the OF switch #3 outputs the relevant packet to the output port “p3”.

Since the output port “p3” of the OF switch #3 is coupled to the port “p1” of the OF switch #2 to which the host #3 is coupled, the relevant packet is transferred to the OF switch #2.

In the OF switch #2, a flow entry (the illustration thereof is omitted) that a packet including the address information “10.3.3.3” is to be output to the output port “p2” is registered. Accordingly, the relevant packet is transferred to the host #3 coupled to the output port “p2”.

In addition, upon receiving, by use of a flow, a packet including the address information “10.4.4.4” of the host #4 as the destination address information, the flow being identified by, for example, the flow ID #4, the OF switch #3 outputs the relevant packet to the output port “p2”.

Since the output port “p2” of the OF switch #3 is coupled to the port “p1” of the OF switch #3 located in the path toward the host #4, the relevant packet is transferred to the OF switch #3.

In the same way, upon receiving, by use of a flow, a packet including the address information “10.5.5.5” of the host #5 as the destination address information, the flow being identified by, for example, the flow ID #5, the OF switch #3 outputs the relevant packet to the output port “p2”.

As described above, the OF switches 2 each perform forwarding of reception packets in accordance with the flow entries of the corresponding flow table.

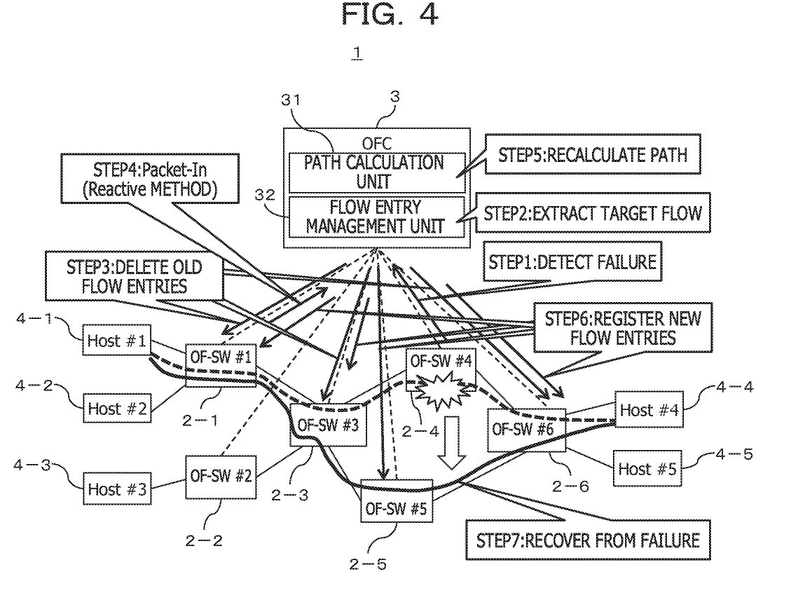

Next, a failure recovery method in a case where a failure occurs in a path through which a flow passes in the above-mentioned OF network will be described with reference to FIG. 4. Note that, in FIG. 4, a case where a failure occurs in the OF switch #4 regarding a path through which a flow between the hosts #1 and #4 passes is exemplarily assumed.

As the failure recovery method, two respective methods called a “proactive method” and a “reactive method” may be applied. Note that since a recovery from a path failure is performed by a resetting of a path as described later, the “failure recovery method” may be called a “path resetting method”.

In the “proactive method”, an alternative path for a flow to pass through a path (for example, the OF switch #4) in which a failure occurrence is detected is recalculated by the OFC 3, and a flow entry of the alternative path is reset in each of the OF switches 2 located in the alternative path.

Note that the “alternative path” may be called a “detour path” or a “new path”. With respect to the “new path”, a path of a flow to pass through the corresponding OF switch 2 in which the failure occurrence is detected may be called an “old path”. In addition, the corresponding OF switch 2 in which the failure occurrence is detected may be conveniently called a “failure point”.

As illustrated in, for example, FIG. 4, upon detecting that a failure occurs in the OF switch #4 (STEP1), the OFC 3 extracts, in, for example, the flow entry management unit 32, a target flow to pass through the OF switch #4 in which the failure occurrence is detected (STEP2).

Note that after a session is established between the OFC 3 and the corresponding OF switch 2, the OFC 3 and the corresponding OF switch 2 transmit and receive, to and from each other, signals for alive monitoring through the established session, thereby enabling the OFC 3 to detect that a failure occurs in the corresponding OF switch 2.

The OFC 3 may periodically transmit, through, for example, the established session, an echo request addressed to the corresponding OF switch 2. In a case where it is difficult to receive, from the corresponding OF switch 2, an echo reply to serve as a response to the relevant echo request within a predetermined time period, the OFC 3 may determine that a failure occurs in the corresponding OF switch 2.

The OFC 3 may instruct to delete the flow entry of the target flow extracted in STEP2, from the flow table in each of the OF switches 2 (in the example of FIG. 4, the OF switches #1, #3, and #6) through which the relevant target flow passes (STEP3). The flow modification message may be used for the relevant deletion instruction.

Along with it, based on the topology information of the OF network, the OFC 3 may calculate a new path of the target flow, by using, for example, the path calculation unit 31 (STEP5). In the example of FIG. 4, a path routed through the OF switches #1, #3, #5, and #6 is determined as the new path.

In addition, the OFC 3 sets and registers a flow entry of the new path between the hosts #1 and #4, in the flow table of each of the OF switches #1, #3, #5, and #6 located in the new path (STEP6). From this, the flow of the old path is relieved by the new path, and a recovery from the failure is achieved (STEP7). Note that the flow modification message may be used for setting and registering the flow entry of the new path.

On the other hand, the “reactive method” may be implemented in the same way as the proactive method, regarding the above-mentioned STEP1 to STEP3.

If a packet of the flow of the old path is received by one of the OF switches #1, #3, and #6 after the flow entry of the old path is deleted from the flow table of each of the OF switch #1, #3, and #6 in STEP3, the relevant packet is treated as an unknown packet.

In response to detection of an unknown packet, the corresponding OF switch 2 may transmit a packet-in that includes the unknown packet and that is addressed to the OFC 3. In other words, the corresponding OF switch 2 in which a flow entry is deleted by the OFC 3 in order to reset a path to the new path may transmit a message that indicates reception of a packet of an unknown data flow and that is addressed to the OFC 3.

Every time a packet-in is received (STEP4), the OFC 3 may perform calculation of a new path with a flow of an unknown packet as a unit, in, for example, the path calculation unit 31 (STEP5).

In addition, the OFC 3 sets and registers flow entries of new paths each calculated every time a packet-in is received, in each of the flow tables of the OF switches 2 each serving as a transmission source of the corresponding packet-in (STEP6). From this, the flow of the old path is relieved by the new path, and a recovery from the failure is achieved (STEP7).

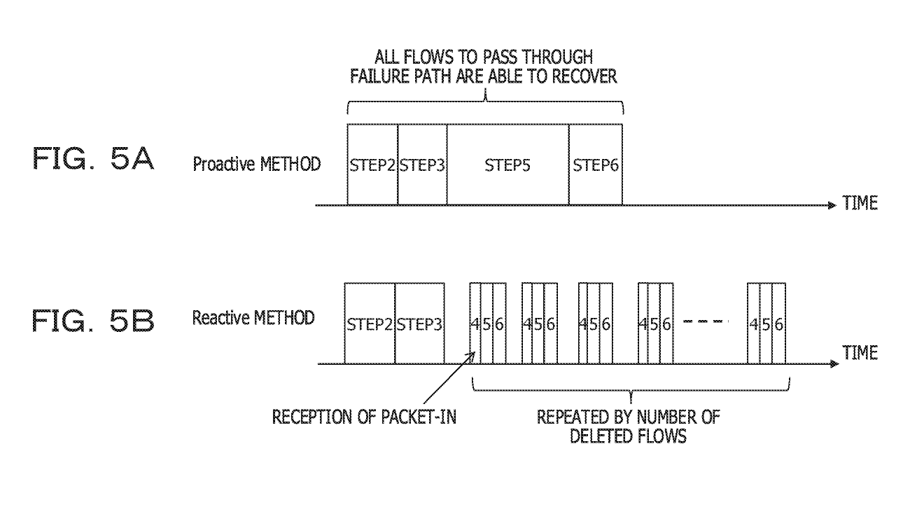

As schematically exemplified in FIG. 5A, in the “proactive method”, a series of processing operations in the above-mentioned STEP2 to STEP6 is implemented. Therefore, it is possible to recover all paths influenced by the failure.

In contrast, as schematically exemplified in FIG. 5B, in the “reactive method”, after STEP2 and STEP3, STEP4 to STEP6 are implemented every time a packet-in is received and are repeatedly implemented by the number of flows whose flow entries are deleted in STEP3.

As described above, compared with the “reactive method”, it may be said that the “proactive method” is able to shorten a time taken to recover from a failure and to perform a high-speed failure recovery, but on the other hand, the load of the OFC 3 is easily increased. In contrast, compared with the “proactive method”, in the “reactive method”, it may be said that while a time taken to recover from a failure is easily lengthened, the load of the OFC 3 is easily kept at a low load.

Therefore, in the present embodiment, enabling failure recovery utilizing the advantage of each of the “proactive method” and the “reactive method” will be considered. Note that the “proactive method” is an example of a “first method” and the “reactive method” is an example of a “second method”.

The “reactive method” serving as an example of the second method is an example of a method in which, compared with the “proactive method” serving as an example of the first method, a processing load of path resetting for the same number of data flows is low and a processing time period is long.

Based on, for example, the load of the OFC 3 and the number of flows serving as failure recovery targets, the OFC 3 adaptively selects the “proactive method” and the “reactive method” and performs failure recovery, for all or some of the flows serving as failure recovery targets. From this, it is possible to suppress an increase in the load of the OFC 3 and to shorten a time taken to recover from a failure.

As an index indicating the load of the OFC 3, a CPU usage rate of the OFC 3 or a memory usage rate of the OFC 3 may be exemplarily used, and the CPU usage rate and the memory usage rate may be used in a composite manner.

Hereinafter, as a non-restrictive example, the CPU usage rate is used as the index indicating the load of the OFC 3. Note that the term CPU is an abbreviation of a “central processing unit”. The CPU usage rate may be restated as a “CPU utilization rate” or a “CPU load”.

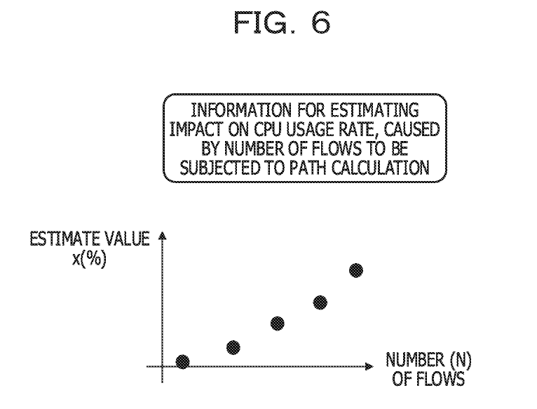

As illustrated in, for example, FIG. 6, in the OFC 3, the processing capacity X(N) [%] of the CPU, used for path calculation of N (N is an natural number) flows, is preliminarily obtained.

In other words, X(N) indicates a variation amount imparted to the CPU usage rate by the path calculation of the number N of flows. Note that “X(N)” is simply abbreviated to “X”. The CPU usage rate X may be an actual measured value or may be an estimate value based on the actual measured value.

For convenience of explanation, hereinafter, the estimate value is used as the CPU usage rate X. In other words, the OFC 3 is able to estimate the variation amount (X) of the CPU usage rate from the number N of flows to serve as failure recovery targets.

Accordingly, it is possible to easily obtain, in a simplified manner, the variation amount (X) of the CPU usage rate for the number N of flows to serve as failure recovery targets, and it is possible to suppress the load of the OFC 3 used for calculating the variation amount X.

Hereinafter, the CPU usage rate X to serve as the estimate value is conveniently represented as a “CPU usage rate X (estimate value)” or a “CPU load estimate value X” in some cases. In contrast, the current CPU usage rate (Y %) of the OFC 3 is conveniently represented as a “CPU usage rate Y (current value)” in some cases.

It may be thought that the CPU usage rate Y indicates the load of the OFC 3, which does not include the variation amount (X) of the CPU usage rate corresponding to the path calculation of the number N of flows. In addition, it may be thought that X+Y indicates the load of the OFC 3, which includes the variation amount (X) of the CPU usage rate corresponding to the path calculation of the number N of flows.

At a time of a failure recovery, the OFC 3 acquires the number N of flows to serve as failure recovery targets and acquires the CPU usage rate X (estimate value) for the relevant number N of flows. Along with it, the OFC 3 acquires the CPU usage rate Y (current value).

In addition, based on a comparison between, for example, the CPU usage rates X and Y and a threshold value A (%), the OFC 3 selects a failure recovery method. Note that the threshold value A is an example of a first threshold value related to the load of the OFC 3.

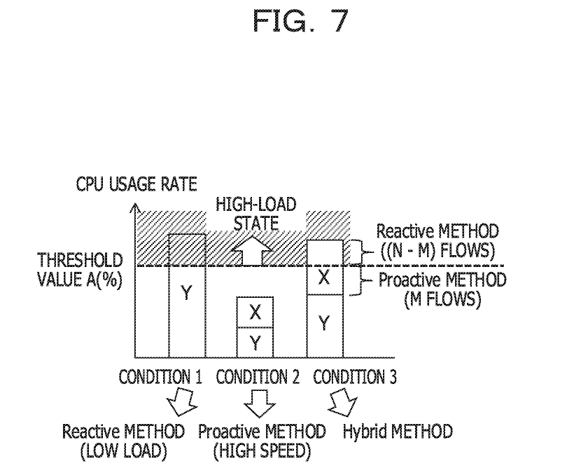

As schematically exemplified in FIG. 7, in a case where Y≧A (a condition 1) is satisfied, the OFC 3 may exemplarily determine as being in a high-load state and may select the “reactive method” in which a low-load operation is available for all the N flows to serve as failure recovery targets.

In addition, if X+Y≦A (a condition 2) is satisfied, the CPU load has a margin. Therefore, as the failure recovery method, the “proactive method” in which a high-speed recovery operation is available for all the N flows to serve as failure recovery targets may be selected.

Furthermore, if X+Y>A (a condition 3) is satisfied, the OFC 3 may select a “hybrid method” as the failure recovery method. The “hybrid method” is a method in which the “proactive method” and the “reactive method” are used in a composite manner.

In, for example, the “hybrid method”, for some flows (for example, M flows) out of the N flows, the “proactive method” in which the high-speed recovery operation is available is selected. For the remaining flows (for example, the number thereof is N−M), the “reactive method” in which the low-load operation is available is selected.

In this regard, however, “M” is an integer satisfying 1≦M<N. It may be thought that the “M flows” correspond to the number of flows falling within a range estimated to be able to satisfy X+Y≦A even in a case of implementing the failure recovery by using the “proactive method”. In other words, it may be thought that the “N−M flows” correspond to the number of flows to satisfy X+Y>A in a case of implementing the failure recovery by using the “proactive method”.

In this way, if the CPU load is not put into the high-load state, the OFC 3 may select the “proactive method” in which the high-speed recovery operation is available. On the other hand, in a case where the CPU load is in the high-load state or in a case where the CPU load is estimated to be put into the high-load state by a failure recovery operation, the “reactive method” in which the low-load operation is available for at least some of the N flows may be selected.

(Example of Configuration of OFC)

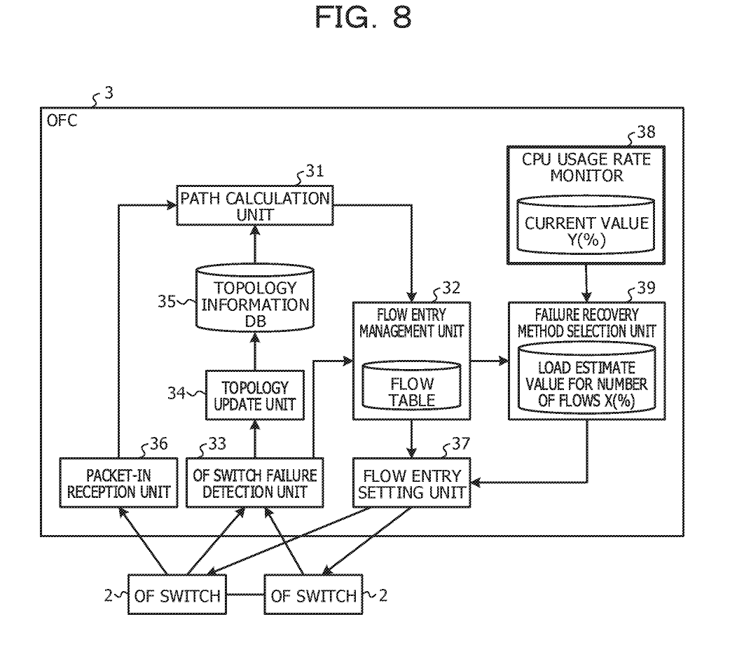

Next, an example of a configuration of the OFC 3 in which the above-mentioned adaptive selection of a failure recovery method is available will be described with reference to FIG. 8 to FIG. 10.

FIG. 8 is a block diagram illustrating an example of a functional configuration of the above-mentioned OFC 3.

As illustrated in FIG. 8, the OFC 3 exemplarily includes the path calculation unit 31 and the flow entry management unit 32, already described, and may further include an OF switch failure detection unit 33, a topology update unit 34, and a topology information database (DB) 35. In addition, the OFC 3 may include a packet-in reception unit 36, a flow entry setting unit 37, a CPU usage rate monitor 38, and a failure recovery method selection unit 39.

By using the already-described alive monitoring, the OF switch failure detection unit 33 exemplarily detects that a failure occurs in one of the OF switches 2 regarded as targets of management and control by the OFC 3.

In response to the failure detection in the OF switch failure detection unit 33, the topology update unit 34 exemplarily updates topology information in the topology information DB 35. Based on the topology information, calculation of a new path for a flow serving as a failure recovery target may be implemented in the path calculation unit 31. In addition, in accordance with the new path obtained by the path calculation unit 31, a flow entry of a flow table may be registered and updated in the flow entry management unit 32.

The packet-in reception unit 36 exemplarily receives a packet-in addressed, to the OFC 3, and transmitted by one of the switches 2 regarded as targets of management and control by the OFC 3. As already described, in the “reactive method”, in response to reception of the packet-in in the packet-in reception unit 36, path calculation based on the path calculation unit 31 may be implemented.

In accordance with a flow entry managed by the flow entry management unit 32, the flow entry setting unit 37 exemplarily sets or updates a flow entry for the flow table in the corresponding OF switch 2. The already-described flow modification (FlowMod) message may be used for the setting or updating of the flow entry for the corresponding OF switch 2.

The CPU usage rate monitor 38 exemplarily monitors the CPU usage rate Y (current value) of the OFC 3.

The failure recovery method selection unit 39 exemplarily acquires the CPU usage rate Y (current value) from the CPU usage rate monitor 38 and acquires, from the flow entry management unit 32, the number (N) of flows to serve as failure recovery targets, thereby obtaining the CPU load estimate value X (see FIG. 6) for the number N of flows.

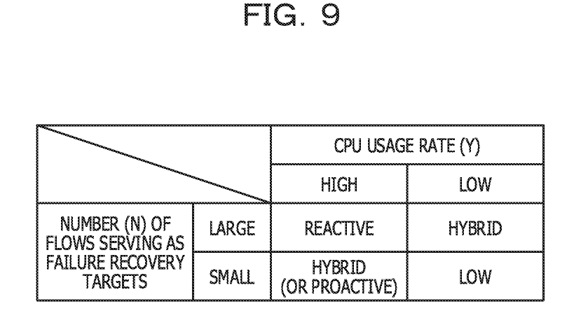

In addition, as described in FIG. 7, based on a comparison between the CPU usage rate Y, the CPU load estimate value X, and the threshold value A, the failure recovery method selection unit 39 selects a failure recovery method. In accordance with, for example, determination criteria (may be called “selection criteria”) exemplified in FIG. 9, the failure recovery method selection unit 39 may select a failure recovery method.

In a case where the CPU usage rate (Y) is already in a high state and the number (N) of flows serving as failure recovery targets is large, in other words, in a case where the condition 1, (Y≧A), described in FIG. 7 is satisfied, the failure recovery method selection unit 39 may exemplarily select the “reactive method”.

In addition, in a case where the CPU usage rate (Y) is in a low state and the number (N) of flows serving as failure recovery targets is small, in other words, in a case where the condition 2, (X+Y≦A), described in FIG. 7 is satisfied, the failure recovery method selection unit 39 may exemplarily select the “proactive method”.

Furthermore, in a case where even if the CPU usage rate (Y) is in a low state, the condition 3, (X+Y>A), described in FIG. 7 is satisfied because the number (N) of flows serving as failure recovery targets is large, the failure recovery method selection unit 39 may select the “hybrid method”.

In addition, in a case where the CPU usage rate (Y) is in a high state and the number (N) of flows serving as failure recovery targets is small, the condition 3, (X+Y>A), described in FIG. 7 is satisfied in some cases and the condition 2, (X+Y≦A), is satisfied in other cases.

In a case where the condition 3 is satisfied, the failure recovery method selection unit 39 may select the “hybrid method”, and in a case where the condition 2 is satisfied, the failure recovery method selection unit 39 may select the “proactive method”. In other words, in a case where the number of flows serving as failure recovery targets is small even if the CPU usage rate is in a high state, the “proactive method” may be selected in some cases.

(Example of Operation of OFC)

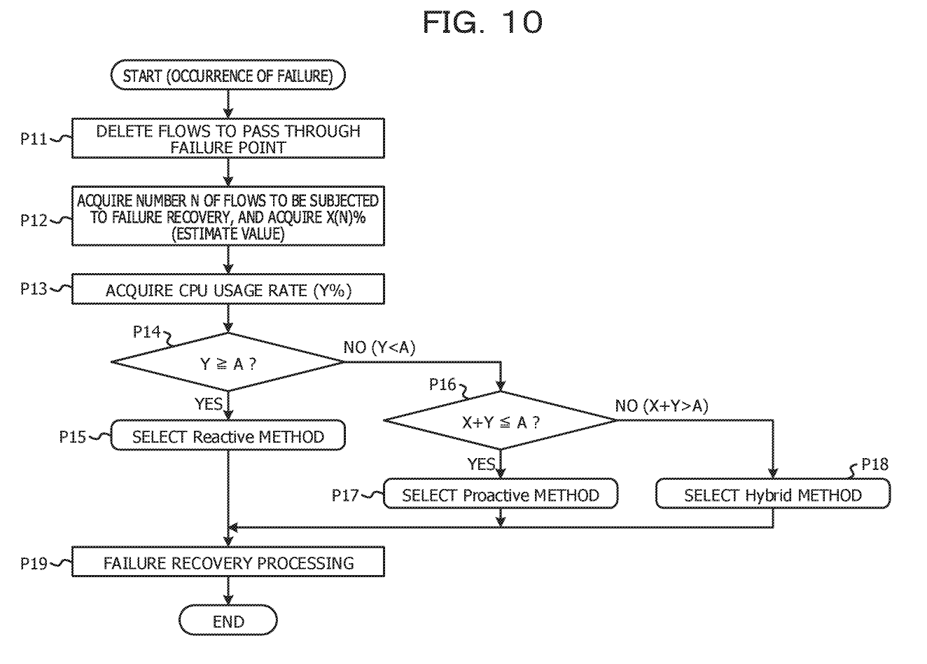

Hereinafter, an example of an operation of the OFC 3 described above will be described with reference to a flowchart in FIG. 10.

As exemplified in FIG. 10, if the OF switch failure detection unit 33 detects that a failure occurs in one of the OF switches 2, the OFC 3 deletes, in the flow entry management unit 32, flow entries of flows to pass through the corresponding OF switch 2 in which the failure occurrence is detected.

In response to the deletion of flow entries in the flow entry management unit 32, the OFC 3 deletes the deleted flow entries from the flow tables of the OF switches 2 related to the flows to pass through a failure point (processing operation P11). By using, for example, the flow entry setting unit 37, the OFC 3 may transmit flow modification messages addressed to the corresponding OF switches 2 and may instruct to delete the corresponding flow entries.

After that, in the OFC 3, the failure recovery method selection unit 39 acquires, from the flow entry management unit 32, the number (N) of flows serving as failure recovery targets and acquires the CPU load estimate value (X) for the acquired number (N) of flows (processing operation P12).

Along with it, the failure recovery method selection unit 39 acquires the current CPU usage rate (Y) from the CPU usage rate monitor 38 (processing operation P13). Note that the order of the processing operation P12 and the processing operation P13 may be reversed. In addition, the processing operation P12 and the processing operation P13 may be implemented in parallel.

In addition, by comparing the CPU usage rate Y with the threshold value A, the failure recovery method selection unit 39 determines whether or not Y≧A (the condition 1) is satisfied (processing operation P14). If Y≧A is satisfied (processing operation P14: YES), the failure recovery method selection unit 39 selects the “reactive method” in which a low-load operation is available (processing operation P15).

In accordance with the “reactive method” selected by the failure recovery method selection unit 39, the OFC 3 implements failure recovery processing (processing operation P19). In response to, for example, reception of a packet-in in the packet-in reception unit 36, the OFC 3 performs, in the path calculation unit 31, calculation of a new path with a flow of an unknown packet as a unit.

In addition, the OFC 3 sets and registers a flow entry of the new path, in the flow table of each of the OF switches 2 located in the new path. From this, the flow of an old path is relieved by the new path, and a recovery from the failure is achieved.

On the other hand, if Y≧A is not satisfied in the threshold value determination in the processing operation P14 (processing operation P14: NO), the failure recovery method selection unit 39 may determine whether or not X+Y≦A (the condition 2) is satisfied (processing operation P16).

If X+Y≦A (the condition 2) is satisfied (processing operation P16: YES), the failure recovery method selection unit 39 selects the “proactive method” (processing operation P17).

In accordance with the “proactive method” selected by the failure recovery method selection unit 39, the OFC 3 implements failure recovery processing (processing operation P19). By using, for example, the path calculation unit 31, the OFC 3 calculates new paths of flows serving as failure recovery targets, based on the topology information.

In addition, the OFC 3 sets and registers flow entries of the new paths, in the flow tables of the respective OF switches 2 located in the new paths. From this, the flows of old paths are relieved by the new paths, and recoveries from the failure are achieved.

Note that if X+Y≧A is not satisfied in the threshold value determination in the processing operation P16 (processing operation P16: NO), the failure recovery method selection unit 39 may determine that X+Y>A (the condition 3) is satisfied, and may select the “hybrid method”.

In accordance with the “hybrid method” selected by the failure recovery method selection unit 39, the OFC 3 implements failure recovery processing (processing operation P19).

Regarding, for example, some flows (for example, M flows) out of the N flows serving as failure recovery targets, the OFC 3 may implement recovery processing by using the “proactive method” in which the high-speed recovery operation is available. Regarding the remaining flows (for example, the number thereof is N−M), the failure recovery method selection unit 39 may implement failure recovery processing by using the “reactive method” in which the low-load operation is available.

As described above, according to the above-mentioned embodiment, at a time of performing a failure recovery of the OF network, the OFC 3 is able to adaptively select a failure recovery method corresponding to the load of the OFC 3 and the number of flows serving as failure recovery targets. Accordingly, it is possible to inhibit the load of the OFC 3 from being put into an overloaded state in association with the failure recovery processing.

In addition, it is possible to inhibit the “reactive method” from being selected for the failure recovery processing despite the fact that the load of the OFC 3 has a margin, the “reactive method” being operable with a low load but consuming time. Accordingly, it is possible to achieve effective utilization of resources such as the CPU processing capacity and the memory capacity of the OFC 3, available for the failure recovery processing. Therefore, it is possible to achieve shortening of a failure recovery time.

(Example of Hardware Configuration of OFC)

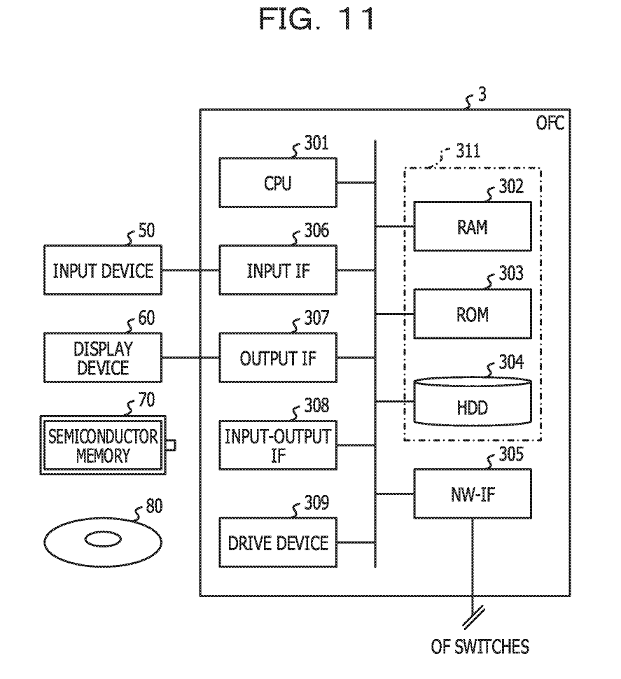

Next, an example of a hardware configuration of the above-mentioned OFC 3 will be described with reference to FIG. 11. As illustrated in FIG. 11, the OFC 3 may exemplarily include a CPU 301, a random access memory (RAM) 302, a read only memory (ROM) 303, a hard disc drive (HDD) 304, and a network interface (NW-IF) 305.

In addition, the OFC 3 may exemplarily include, as options, all or some of an input interface (IF) 306, an output IF 307, an input-output IF 308, and a drive device 309.

The CPU 301, the RAM 302, the ROM 303, the HDD 304, the individual IFs 305 to 308, and the drive device 309 may be exemplarily coupled to a communication bus 310 and may be communicatable with each other via the CPU 301.

The CPU 301 is an example of a processor circuit or processor device having an arithmetic capacity. As an example of the processor circuit or the processor device, another arithmetic processing device, for example, an integrated circuit (IC) such as a micro processing unit (MPU), or a digital signal processor (DSP) may be used in place of the CPU 301. The processor circuit or processor device having the arithmetic capacity may be called a “computer”.

Each of the RAM 302 and the ROM 303 is an example of a memory storing therein various data and programs. A “program” may be called “software” or an “application”.

The RAM 302 may be used as a working memory of the CPU 301. Data and programs stored in, for example, the ROM 303 and the HDD 304 may be deployed in the RAM 302 and may be used for an arithmetic operation of the CPU 301.

The HDD 304 is an example of a storage device and stores therein various data and programs. As other examples of the storage device, a semiconductor drive device such as a solid state drive (SSD), a nonvolatile memory such as a flash memory, and so forth are cited. Accordingly, the HDD 304 may be replaced by the SSD or the flash memory.

Programs stored in the HDD 304 may include a program (may be conveniently called an “OFC program”) able to realize all or some of various kinds of functions to serve as the OFC 3 exemplified in FIG. 8. Note that all or some of program codes forming the OFC program may be stored in the ROM 303 or may be described as part of an operating system (OS).

Data stored in the HDD 304 may include the topology information (the DB 35), the flow table managed by the flow entry management unit 32, information of the CPU load estimate value (X) for the number (N) of flows, exemplified in FIG. 6, the determination threshold value (A) of the CPU usage rate, and so forth.

The CPU 301 deploys, in, for example, the RAM 302, and executes the OFC program stored in the HDD 304, thereby realizing various kinds of functions to serve as the OFC 3. Note that the RAM 302, the ROM 303, and the HDD 304 may be conveniently collectively called a “storage unit 311” in the OFC 3.

Programs and data may be provided in a form of being recorded in a computer-readable recording medium 80. As examples of the recording medium, a flexible disk, a CD-ROM, a CD-R, a CD-RW, an MO, a DVD, a Blu-ray Disc, a portable hard disk, and so forth are cited. In addition, a semiconductor memory 70 such as a Universal Serial Bus (USB) memory is an example of the recording medium 80.

Programs and data stored in the semiconductor memory 70 may be exemplarily read by the CPU 301 via the input-output IF 308. In addition, the programs and the data stored in the recording medium 80 may be exemplarily read by the CPU 301 via the drive device 309.

Note that programs and data may be provided (downloaded) to the OFC 3 by a server or the like via a communication line. Programs and data may be provided to the OFC 3 via, for example, the NW-IF 305. In addition, programs and data may be provided to the OFC 3 by an input device 50 via the input IF 306.

The NW-IF 305 is exemplarily an example of a communication interface enabling coupling and communication with the OF switches 2. An interface to support the already-described TCP and TLS may be exemplarily applied to the NW-IF 305.

The input device 50 may be exemplarily coupled to the input IF 306. Examples of the input device 50 include a keyboard, a mouse, an operation button, a microphone, and so forth.

A display device 60 to serve as an example of an output device may be exemplarily coupled to the output IF 307. A liquid crystal display or the like may be applied to the display device 60. It may be thought that a touch panel type liquid crystal display corresponds to the input device 50. Note that as another example of the output device, a printer, a speaker, or the like may be coupled to the output IF 307.

The input device 50 may be used for works such as registration or a change of a setting for the OFC 3, various kinds of operations of the OFC 3, inputting of data thereto, the works being based on an operator of the OFC 3. The display device 60 to serve as an example of the output device may be used for confirmation of a setting, based on the operator of the OFC 3, and outputting of various kinds of notices and so forth to the operator.

Note that an example of a hardware configuration of the OFC 3, exemplified in FIG. 11, is merely an exemplification and a decrease or an increase in hardware may be arbitrarily made in the OFC 3. For example, addition or deletion of an arbitrary hardware block, division, integration based on an arbitrary combination, addition or deletion of a bus, and so forth may be arbitrarily performed in the OFC 3.

(Example of Configuration of OF Switch)

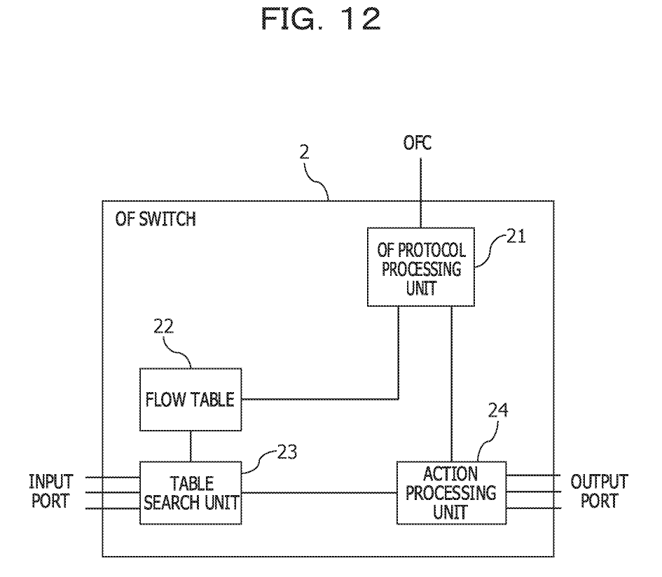

Next, an example of functional configurations of the above-mentioned OF switches 2 will be described with reference to FIG. 12. As illustrated in FIG. 12, the OF switches 2 may each exemplarily include an OF protocol processing unit 21, a flow table 22, a flow table search unit 23, and an action processing unit 24.

The OF protocol processing unit 21 exemplarily implements transmission and reception processing, based on the OF protocol, with the OFC 3. The transmission processing based on the OF protocol may include, for example, transmission processing of a control message including the already-described packet-in. On the other hand, the reception processing based on the OF protocol may include reception processing of a control message including the flow modification message or the packet-out that is already-described and that is transmitted by the OFC 3.

The flow table 22 exemplarily stores therein the flow entries described in FIG. 2 and FIG. 3. In response to the reception processing of the flow modification message in the OF protocol processing unit 21, a flow entry may be set and registered in the flow table 22.

The table search unit 23 exemplarily searches, within the flow table 22, for a flow entry whose rule matches a packet received from one of the hosts 4 or the other OF switch 2, and in accordance with the hit flow entry, the table search unit 23 transfers the reception packet to an output port corresponding to a destination.

The action processing unit 24 performs, on the reception packet transferred by the table search unit 23, processing in accordance with an “action” specified in the flow entry. As the “action”, transfer (forwarding), discarding (dropping), or the like of a packet may be specified.

Note that in a case where no flow entry hits the reception packet in the table search unit 23, the relevant reception packet may be treated as an unknown packet and may be transferred to the OF protocol processing unit 21 by, for example, the action processing unit 24. The OF protocol processing unit 21 may address, to the OFC 3, and transmit the unknown packet by using the already-described packet-in.

(Example of Hardware Configuration of OF Switch)

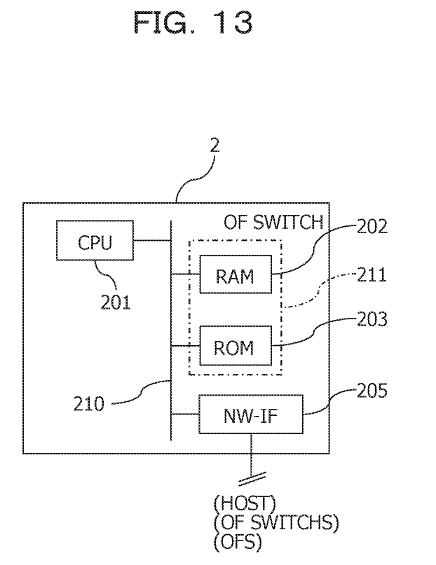

Next, an example of hardware configurations of the above-mentioned OF switches 2 will be described with reference to FIG. 13. As illustrated in FIG. 13, the OF switches 2 may each exemplarily include a CPU 201, a RAM 202, a ROM 203, and an NW-IF 205.

The CPU 201, the RAM 202, the ROM 203, and the NW-IF 205 may be exemplarily coupled to a communication bus 210 and may be communicatable with one another via the CPU 201.

In the same way as the CPU 301 in the OFC 3, the CPU 201 is an example of a processor circuit or processor device having an arithmetic capacity. The CPU 201 may be replaced by another arithmetic processing device, for example, an IC such as an MPU, or a DSP.

Each of the RAM 202 and the ROM 203 is an example of a memory storing therein various data and programs.

The RAM 202 may be used as a working memory of the CPU 201. Data and programs stored in, for example, the ROM 203 may be deployed in the RAM 202 and may be used for an arithmetic operation of the CPU 201.

Programs stored in the ROM 203 may include a program (may be conveniently called an “OF switch program”) able to realize all or some of various kinds of functions to serve as the OF switch 2 exemplified in FIG. 12.

The already-described flow table may be stored in the RAM 202. The flow table may be stored in a nonvolatile memory (the illustration thereof is omitted), different from the RAM 202 and provided in the corresponding OF switch 2.

The CPU 201 deploys, in, for example, the RAM 202, and executes the OF switch program stored in the ROM 203, thereby realizing various kinds of functions to serve as the corresponding OF switch 2. Note that the RAM 202 and the ROM 203 may be conveniently collectively called a “storage unit 211” in the corresponding OF switch 2.

The NW-IF 205 is exemplarily an example of a communication interface enabling coupling and communication with one of the hosts 4, the other OF switches 2, and the OFC 3. The NW-IF 205 may exemplarily include an interface to support TCP/IP, regarding DP communication with the hosts 4 and the other OF switches 2. In addition, regarding CP communication with the OFC 3, the NW-IF 205 may include an interface to support the TCP or TLS.

### First Example of Modification

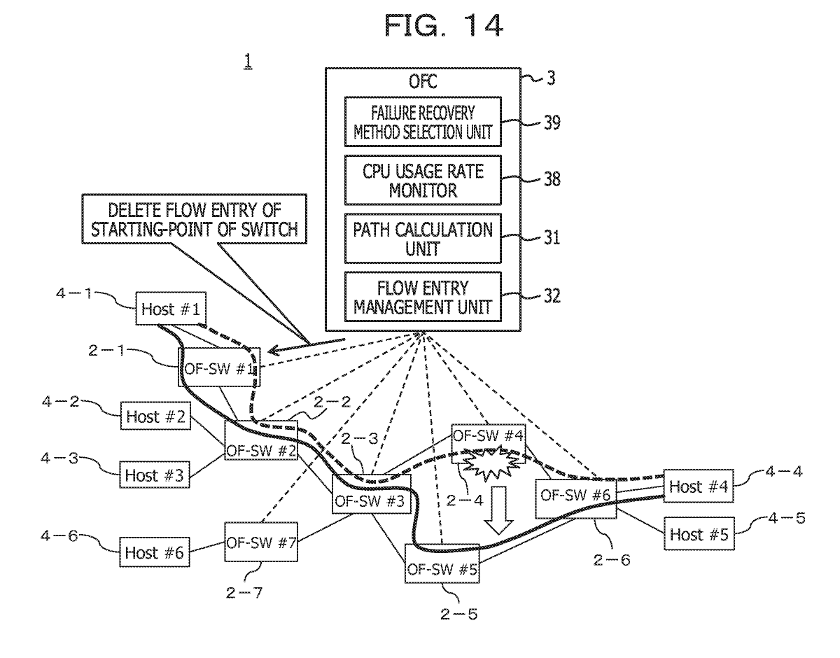

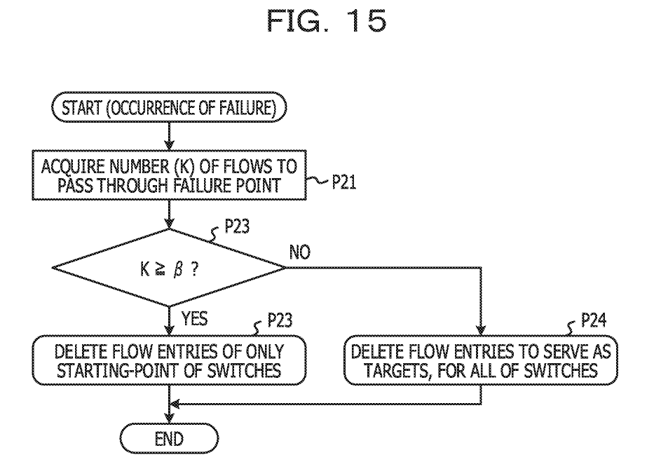

Next, a first example of a modification to the above-mentioned embodiment will be described with reference to FIG. 14 and FIG. 15. In the first example of a modification, an example in which a processing load in a case of the OFC 3 deleting flow entries in the corresponding OF switches 2 is reduced will be described.

If, in the processing operation P11 in FIG. 10, the OFC 3 unlimitedly define, as targets of deletion, flow entries in all the OF switches 2 related to flows to pass through a failure point, in a case where the number of flows to serve as deletion targets is too large, there is a possibility that the load of the OFC 3 excessively rises.

If the load of the OFC 3 excessively rises, there is a possibility that a failure recovery is delayed or the failure recovery is not completed.

Therefore, in the first example of a modification, as schematically exemplified in FIG. 14, the OF switches 2 to serve as candidates in which flow entries are to be deleted may be limited to one of the OF switches 2 (for example, the OF switch #1) corresponding to a starting point of a flow to pass through a failure point (for example, the OF switch #4).

From this, it is possible to reduce the number of flow entries to be deleted from the OF switches 2 by the OFC 3, and it is possible to reduce a processing load associated with flow entry deletion based on the OFC 3. Note that the OF switch 2 corresponding to the starting point of the flow to pass through the failure point may be conveniently called a “starting-point OF switch 2”.

FIG. 15 illustrates an example of an operation thereof by using a flowchart. As exemplified in FIG. 15, in, for example, the flow entry management unit 32 (see FIG. 8), the OFC 3 acquires the number K of flows to pass through a failure point (processing operation P21). Note that “K” is a natural number and exemplarily satisfies K≧N (the number of flows to serve as failure recovery targets).

In addition, in the flow entry management unit 32, the OFC 3 exemplarily compares the number K of flows with a threshold value β, thereby determining whether or not K≧β is satisfied (processing operation P22). “β” is an example of a second threshold value and is a natural number.

“β” exemplarily corresponds to a value by which it may be determined that if the OFC 3 performs, on the related OF switches 2, processing for sequentially deleting flow entries of β flows, the load of the OFC 3 (for example, the CPU usage rate Y) is put into a high-load state (Y>A). Note that the threshold value β may be exemplarily stored in the storage unit 311 exemplified in FIG. 11.

If, as a result of the threshold value determination, K≧β is satisfied (processing operation P22: YES), the OFC 3 may exemplarily determine, in the flow entry management unit 32, only the OF switches 2 corresponding to the starting points of flows to pass through the failure point, as targets of flow entry deletion. In response to the relevant determination, by using, for example, the flow entry setting unit 37, the OFC 3 may transmit, only to the starting-point OF switches 2, flow modification messages to instruct to delete flow entries (processing operation P23).

On the other hand, if, as a result of the threshold value determination, K<β is satisfied (processing operation P22: NO), the OFC 3 may determine all the OF switches 2 related to flows to pass through the failure point, as targets of flow entry deletion. In response to the relevant determination, by using, for example, the flow entry setting unit 37, the OFC 3 may transmit flow modification messages to instruct to delete flow entries, to all the OF switches 2 related to flows to pass through the failure point (processing operation P24).

Note that regarding one of the OF switches 2 (for example, the OF switch #3) in which an “action” is different even if “match rules” are equal between an old flow to be deleted and a new flow after a failure recovery, the OFC 3 may register a new flow entry after deleting an old flow entry.

In this regard, however, in the OF switch #3, while leaving the old flow entry, the OFC 3 may assign, to the new flow entry, a priority higher than that of the old flow entry and register the new flow entry in the corresponding flow table. In this case, for the OF switch #3, the OFC 3 may implement priority management of flows.

Regarding one of the OF switches 2 (for example, the OF switch #2) in which “match rules” and “actions” are equal between new and old flows, the OFC 3 may leave a flow entry of an old flow in the relevant OF switch #2 without deleting the flow entry of the old flow.

Alternatively, the flow entry of the old flow in the OF switch #2 may be automatically erased in response to time-out or may be deleted by the OFC 3 in a case where the load of the OFC 3 falls below a threshold value.

### Second Example of Modification

In the above-mentioned first example of a modification, owing to too many flows to serve as deletion targets, the number of flow entries to be deleted in the starting-point OF switches 2 becomes large in some cases. If deletion processing of flow entries is concentrated on the starting-point OF switches 2, there is a possibility that the loads of the starting-point OF switches 2 excessively rise, thereby delaying the deletion processing.

Therefore, in a case where the number of flow entries to be deleted in the starting-point OF switches 2 is too large, the deletion processing of flow entries may be dispersively implemented in the OF switches 2 (in this regard, however, some of the OF switches 2 through which flows serving as failure recovery targets pass) including the starting-point OF switches 2.

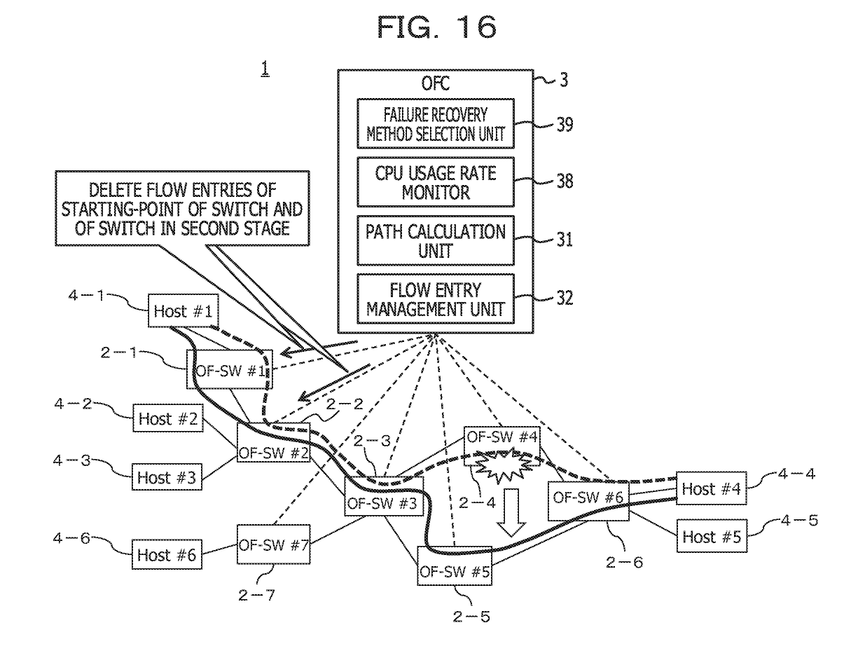

As schematically illustrated in, for example, FIG. 16, some of flow entries serving as deletion targets may be deleted in the starting-point OF switch #1, and deletion of the remaining flow entries may be implemented in the OF switch #2 located in a subsequent stage.

From this, it is possible to parallelize deletion processing of flow entries by the OF switches 2, and it is possible to accelerate the speed of the deletion processing.

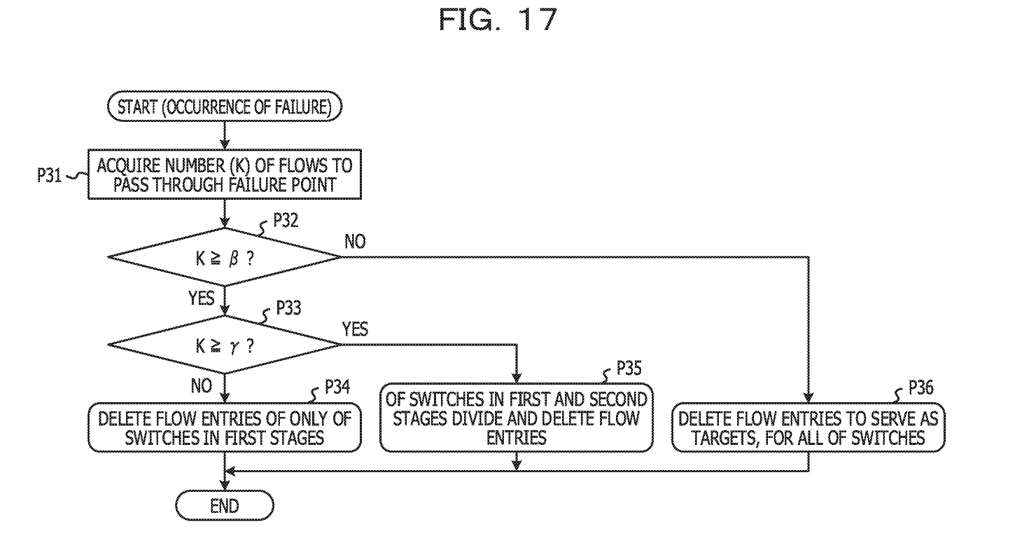

FIG. 17 exemplifies an example of an operation of a second example of a modification by using a flowchart. As exemplified in FIG. 17, in the same way as in the first example of a modification, in, for example, the flow entry management unit 32 (see FIG. 8), the OFC 3 acquires the number K of flows to pass through a failure point (processing operation P31).

In addition, in the same way as in the first example of a modification, in the flow entry management unit 32, the OFC 3 may exemplarily compare the number K of flows with the threshold value β, thereby determining whether or not K≧β is satisfied (processing operation P32).

If, as a result of the threshold value determination, K≧β is satisfied (processing operation P32: YES), in the flow entry management unit 32, the OFC 3 may compare the number K of flows with a threshold value γ and may further determine whether or not K≧γ is satisfied (processing operation P33).

Note that “γ” is a natural number satisfying γ<β. “γ” exemplarily corresponds to a value by which it may be determined that if the OFC 3 instructs one of the OF switches 2 to perform processing for sequentially deleting flow entries of γ flows, the load of the relevant OF switch 2 is put into a high-load state greater than or equal to a (third) threshold value in accordance with the deletion processing.

If, as a result of the threshold value determination, K<γ is satisfied (processing operation P33: NO), the OFC 3 may determine that even if deletion processing of flow entries of K flows is performed on the starting-point OF switches 2, the load of each of the starting-point OF switches 2 is not put into a high-load state.

Accordingly, in the same way as in the first example of a modification, in the flow entry management unit 32, the OFC 3 may determine only the starting-point OF switch #1 as a target of flow entry deletion. In response to the relevant determination, by using, for example, the flow entry setting unit 37, the OFC 3 may transmit, only to the starting-point OF switch #1, a flow modification message to instruct to delete flow entries (processing operation P34).

On the other hand, if, as a result of the threshold value determination in the processing operation P33, K≧γ is satisfied (processing operation P33: YES), the OFC 3 may determine that if deletion processing of flow entries of K flows is performed on the starting-point OF switches #1, the loads of the starting-point OF switches #1 are put into high-load states.

Therefore, in the flow entry management unit 32, in addition to the starting-point OF switch #1 of a flow to pass through the failure point, the OFC 3 may determine the OF switch #2 located in a subsequent stage of the relevant flow, as a target of flow entry deletion.

In other words, in addition to the starting-point OF switch #1, the OFC 3 may add the OF switch #2 located in a stage subsequent to the starting-point OF switch #1 in a flow serving as a failure recovery target, to the candidate OF switches 2 on which deletion of flow entries is to be performed.

In addition, by using, for example, the flow entry setting unit 37, the OFC 3 may instruct the OF switch #1 to delete some of flow entries of K flows and may instruct the OF switch #2 to delete the remaining flow entries (processing operation P35).

From this, deletion of flow entries is able to be distributed or divided and implemented by the starting-point OF switch #1 and the OF switch #2 located in a subsequent stage.

Note that in a case where, as a result of the threshold value determination in the processing operation P32, K<β is satisfied (processing operation P32: NO), in the same way as in the first example of a modification, the OFC 3 may determine all the OF switches 2 related to flows to pass through the failure point, as targets of flow entry deletion. In response to the relevant determination, by using, for example, the flow entry setting unit 37, the OFC 3 may transmit flow modification messages to instruct to delete flow entries, to all the OF switches 2 related to flows to pass through the failure point (processing operation P36).

While, in the above-mentioned example, the number of the OF switches 2 to divide deletion processing of flow entries is “2”, the deletion processing may be divided by 3 or more (in this regard, however, less than the number of the OF switches 2 through which flows serving as failure recovery targets pass) OF switches 2 including the starting-point OF switch #1.

### Third Example of Modification

In a case of implementing the failure recovery by using the “proactive method”, the OFC 3 may perform recovery processing on flows serving as failure recovery targets, in accordance with a predetermined priority. Note that in a case where the failure recovery is implemented by using the “proactive method”, a case where some flows are subjected to the failure recovery by using the “proactive method” in the “hybrid method” may be included while not being limited to a case where all flows serving as failure recovery targets are subjected to the failure recovery by using the “proactive method”. In addition, the priority of the failure recovery may be exemplarily a priority that a flow whose traffic amount is larger is subjected to the recovery processing on a priority basis.

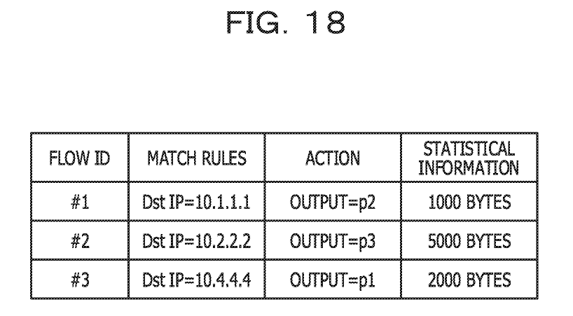

As illustrated in, for example, FIG. 18, in the flow entry management unit 32, the OFC 3 may manage statistical information of a traffic amount for each of flows, by using the flow table. In the example of FIG. 18, the statistical information of a traffic amount (bytes) per unit time is managed for each of flows (IDs), by using the flow table.

Note that in order to acquire, from the corresponding OF switch 2, the statistical information of a traffic amount for each of flows, the OFC 3 may exemplarily address, to the corresponding OF switch 2, and transmit a message to request the statistical information. The relevant message may be called a statistical information request message and may be exemplarily represented as “StatsRequest”.

In response to reception of the statistical information request message, the corresponding OF switch 2 may generate and transmit a reply message including the statistical information of a traffic amount for each of flows while addressing to the OFC 3. The reply message for the statistical information request message may be exemplarily represented as “StatsReply”.

By receiving the relevant reply message from the corresponding OF switch 2, the OFC 3 is able to acquire the statistical information of a traffic amount for each of flows in the corresponding OF switch 2.

In addition, in the OFC 3, in a case of selecting, for example, the “proactive method”, the failure recovery method selection unit 39 may determine that a flow whose traffic amount exceeds a set threshold value has a priority higher than those of other flows.

In response to the relevant determination, the failure recovery method selection unit 39 may perform recovery processing on the flow whose priority is high, on a priority basis. In, for example, the example of FIG. 18, the failure recovery method selection unit 39 may implement the failure recovery processing in the order of the flow ID=#2, the flow ID=#3, and the flow ID=#1.

In this way, a flow in which the statistical information of a traffic amount thereof is larger is subjected to recovery processing on a priority basis. Accordingly, it is possible to shorten a recovery time of a flow whose traffic amount is large and that is considered to be greatly influenced by a failure occurrence.

### Fourth Example of Modification

In the already-described embodiment, an example in which the “hybrid method” is selected in a single uniform way in a case where the condition 3, (X+Y>Y), is satisfied in the OFC 3 as exemplified in FIG. 7 is described.

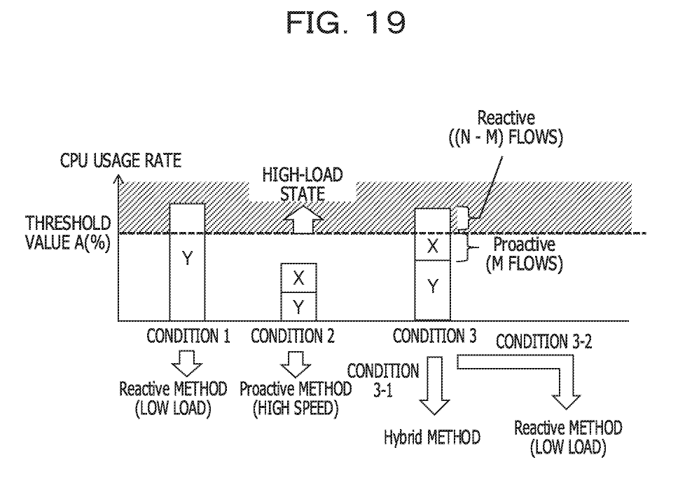

As exemplified in FIG. 19, in a fourth example of a modification, an example in which one of the “hybrid method” and the “reactive method” is selected further based on conditions 3-1 and 3-2 in a case where the condition 3 is satisfied will be described.

The conditions 3-1 and 3-2 are conditions each exemplarily indicating “whether or not a high speed is desired for a failure recovery”. Information indicating the conditions 3-1 and 3-2 may be exemplarily stored in the storage unit 311 in the OFC 3.

In, for example, a case where the condition 3-1, “a high speed is desired for a failure recovery”, is satisfied, the failure recovery method selection unit 39 (see FIG. 8) may select the “hybrid method”. In the “hybrid method”, some of flows serving as failure recovery targets are subjected to the recovery processing by using the “proactive method” in which a high-speed recovery operation is available. Therefore, it is possible to achieve a high-speed recovery, compared with a case where all the flows serving as failure recovery targets are subjected to the recovery processing by using the “reactive method”.

In contrast, a case where the condition 3-2, “a high speed is not desired for a failure recovery”, is satisfied, the failure recovery method selection unit 39 may select, as a recovery processing method, the “reactive method” in which a low-load operation is available for all the flows serving as failure recovery targets.

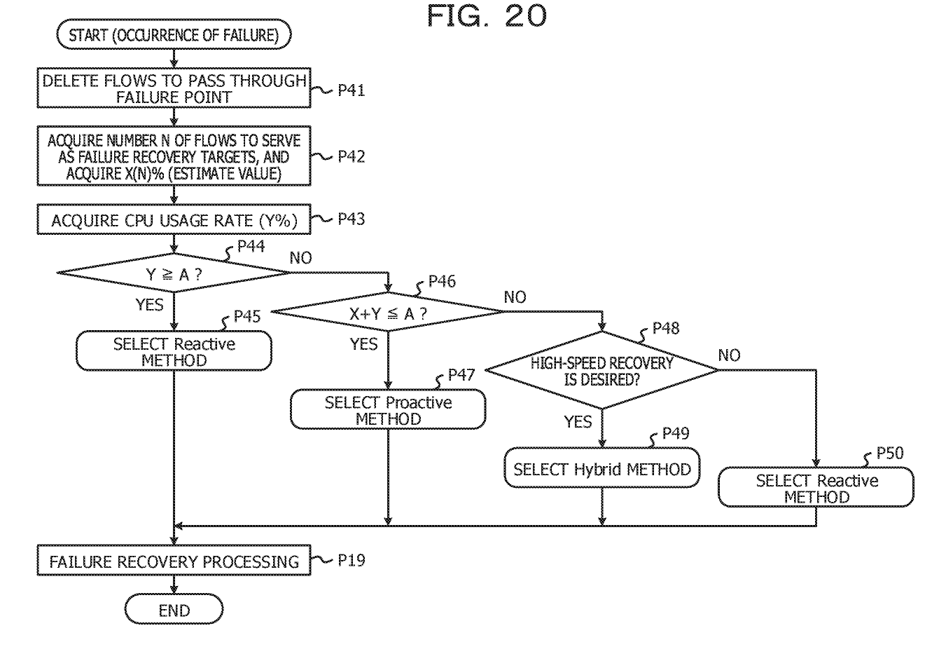

Hereinafter, an example of an operation of the OFC 3 of the fourth example of a modification will be described with reference to FIG. 20. In FIG. 20, processing operations P41 to P47 and P19 may be the same as or similar to the processing operations P11 to P17 and P19, respectively, described in FIG. 10.

In the OFC 3, if, for example, the condition 1, (Y≧A), is satisfied (processing operation P44: YES), the failure recovery method selection unit 39 may select the “reactive method” in which a low-load operation is available (processing operation P45).

If the condition 1 is not satisfied and the condition 2, (X+Y≦A), is satisfied (processing operation P44: NO and processing operation P46: YES), the failure recovery method selection unit 39 may select the “proactive method” in which a high-speed recovery operation is available (processing operation P47).

If the condition 2 is not satisfied, due to X+Y>A (processing operation P46: NO), the failure recovery method selection unit 39 may further determine whether or not a high speed is desired for the failure recovery, in other words, whether the condition 3-1 or the condition 3-2 is satisfied (processing operation P48).

In a case where a high speed is desired for the failure recovery (processing operation P48: YES), the failure recovery method selection unit 39 may select, as a failure recovery method, the “hybrid method” for the N flows serving as failure recovery targets (processing operation P49).

The failure recovery method selection unit 39 may select, for, for example, M flows out of the N flows, the “proactive method” in which a high-speed recovery operation is available and may select, for the remaining (N−M) flows, the “reactive method” in which a low-load operation is available.

On the other hand, in a case where a high speed is not desired for the failure recovery (processing operation P48: NO), the failure recovery method selection unit 39 may select, as a failure recovery method, the “reactive method” for all the N flows serving as failure recovery targets (processing operation P50).

From this, in a case where X+Y>A is satisfied and the OFC 3 is in a high-load state, all the flows serving as failure recovery targets are subjected to the recovery processing by using the “reactive method”. In this case, while, compared with the “hybrid method”, it takes a time to recover from a failure, it is possible to keep the load of the OFC 3 at a low level.

### Fifth Example of Modification

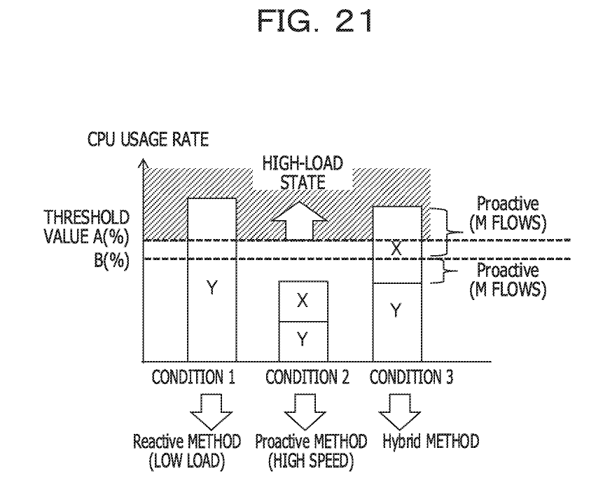

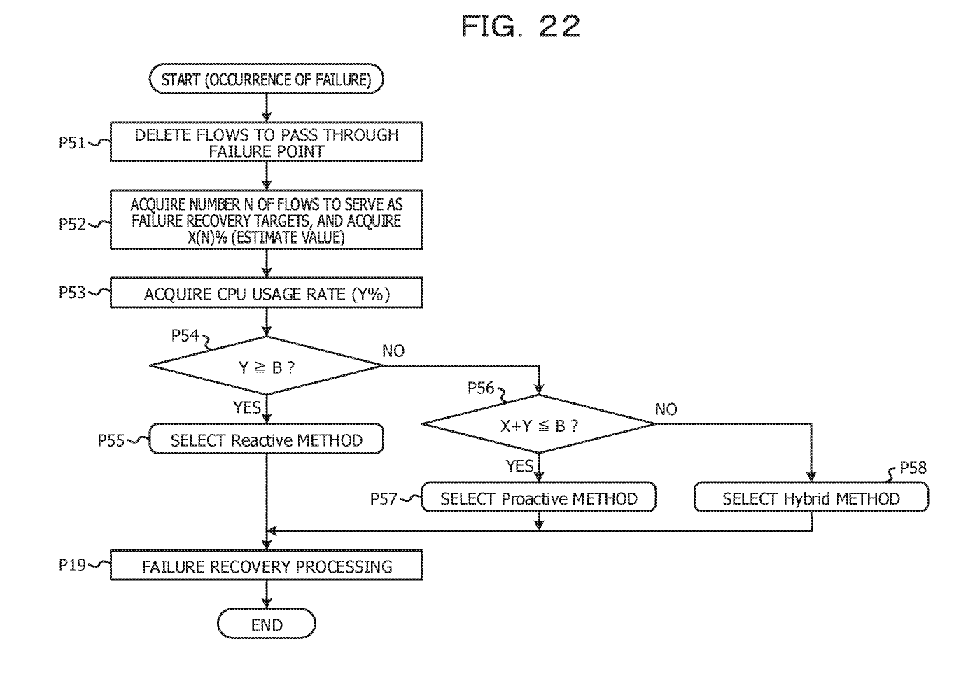

Next, a fifth example of a modification to the already-described embodiment will be described with reference to FIG. 21 and FIG. 22. In the same way as FIG. 7 or FIG. 19, FIG. 21 is a diagram illustrating an example of a selection condition for a failure recovery method in the OFC 3 (for example, the failure recovery method selection unit 39).

In the fifth example of a modification, upon the “reactive method” being selected, a load corresponding to reception processing of a packet-in is generated in the OFC 3. Therefore, the relevant load (may be conveniently called a “packet-in processing load”) may be considered for the selection condition for a failure recovery method.

For example, a threshold value B [%] lower than the already-described threshold value A [%] by which it may be determined that the OFC 3 is in a high-load state is set in the OFC 3 in advance. The threshold value B may be exemplarily set by considering a margin corresponding to the packet-in processing load with respect to the threshold value A. The threshold value B may be stored in the storage unit 311 in the OFC 3.

In the OFC 3, the failure recovery method selection unit 39 may select the “reactive method” if, for example, Y≧B (the condition 1) is satisfied, the failure recovery method selection unit 39 may select the “proactive method” if X+Y≦B (the condition 2) is satisfied, and the failure recovery method selection unit 39 may select the “hybrid method” if X+Y>B (the condition 3) is satisfied.

In the “hybrid method”, the “proactive method” may be exemplarily selected for (M−α) flows out of the N flows serving as failure recovery targets, and the “reactive method” may be exemplarily selected for the remaining (N−M+α) flows. “α” exemplarily indicates the number of flows satisfying X (M−α)+Y=B [%].

Hereinafter, an example of an operation of the OFC 3 of the fifth example of a modification will be described with reference to a flowchart in FIG. 22. In FIG. 22, processing operations P51 to P53 and P19 may be the same as or similar to the processing operations P11 to P13 and P19, respectively, described in FIG. 10.

In the OFC 3, if, for example, the CPU load estimate value X and the current CPU usage rate Y are acquired, first the failure recovery method selection unit 39 may determine whether or not Y≧B (the condition 1) is satisfied (processing operation P54).

If Y≧B (the condition 1) is satisfied (processing operation P54: YES), the failure recovery method selection unit 39 may select the “reactive method” in which a low-load operation is available, for all the N flows serving as failure recovery targets (processing operation P55).

On the other hand, if Y≧B (the condition 1) is not satisfied (processing operation P54: NO), in other words, if Y<B is satisfied, the failure recovery method selection unit 39 may further determine whether or not X+Y≦B (the condition 2) is satisfied (processing operation P56).

If X+Y≦B (the condition 2) is satisfied, (processing operation P56: YES), the failure recovery method selection unit 39 may select the “proactive method” in which a high-speed recovery operation is available, for all the N flows serving as failure recovery targets (processing operation P57).

If X+Y≦B (the condition 2) is not satisfied (processing operation P56: NO), in other words, if X+Y>B is satisfied, the failure recovery method selection unit 39 may select the “hybrid method” (processing operation P58). As, for example, already described, the failure recovery method selection unit 39 may select the “proactive method” for (M−α) flows and may select the “reactive method” for the remaining (N−M+α) flows.

As described above, according to the fifth example of a modification, the packet-in processing load of the OFC 3 is added to the selection condition for a failure recovery method. Therefore, even if the “reactive method” is selected as a failure recovery method, it is possible to inhibit the load of the OFC 3 from being put into a high-load state by the packet-in processing load.

### Sixth Example of Modification

The aspect, “the packet-in processing load is added to the selection condition for a failure recovery method”, of the above-mentioned fifth example of a modification may be applied to the fourth example of a modification (for example, FIG. 20). In a case where, for example, X+Y≧B is satisfied, the failure recovery method selection unit 39 may select one of the “hybrid method” and the “reactive method”, depending on whether a high speed is desired for the failure recovery.

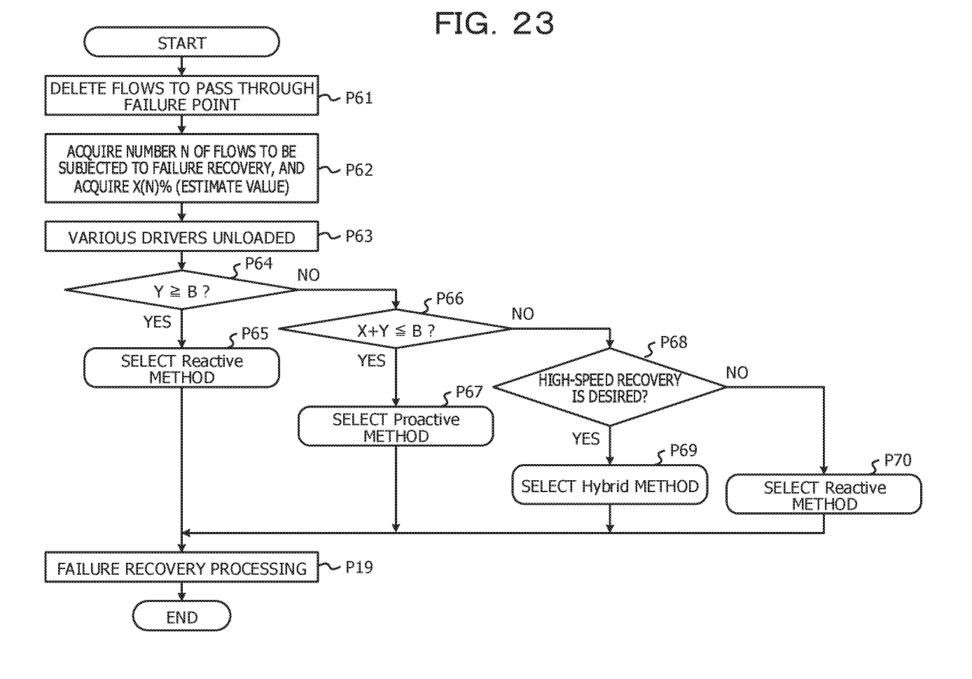

FIG. 23 exemplifies an example of an operation of a sixth example of a modification by using a flowchart. As easily understood from a comparison between FIG. 23 and FIG. 20, FIG. 23 corresponds to a flowchart in which the determination processing operations in the processing operation P44 and the processing operation P46 in FIG. 20, which each use the threshold value A, are replaced with determination processing operations in respective processing operations P64 and P66, which each use the threshold value B.

Note that processing operations P61 to P63, P65, P67, and P68 to P70 in FIG. 23 may be the same as or similar to the processing operations P41 to P43, P45, P47, and P48 to P50, respectively, in the FIG. 20.

In the OFC 3, if, for example, Y≧B is satisfied (processing operation P64: YES), the failure recovery method selection unit 39 may select the “reactive method” in which a low-load operation is available (processing operation P65).

If Y≧B is not satisfied and (X+Y≦B) is satisfied (processing operation P64: NO and processing operation P66: YES), the failure recovery method selection unit 39 may select the “proactive method” in which a high-speed recovery operation is available (processing operation P67).

If X+Y≧A is satisfied (processing operation P66: NO), the failure recovery method selection unit 39 may further determine whether or not a high speed is desired for the failure recovery (processing operation P68).

In a case where a high speed is desired for the failure recovery (processing operation P68: YES), the failure recovery method selection unit 39 may select the “hybrid method” for the N flows serving as failure recovery targets (processing operation P69).

The failure recovery method selection unit 39 may select the “proactive method” for, for example, (M−α) flows out of the N flows serving as failure recovery targets and may select the “reactive method” for the remaining (N−M+α) flows.

On the other hand, in a case where a high speed is not desired for the failure recovery (processing operation P68: NO), the failure recovery method selection unit 39 may select, as a failure recovery method, the “reactive method” for all the N flows serving as failure recovery targets (processing operation P70).

As described above, according to the sixth example of a modification, it is possible to obtain the same function effect as that of the fourth example of a modification, and furthermore, in the same way as in the fifth example of a modification, even if the “reactive method” is selected as a failure recovery method, it is possible to inhibit the load of the OFC 3 from being put into a high-load state by the packet-in processing load.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control device configured to control a plurality of network switches provided in a plurality of communication paths including a first communication path and a second communication path, the control device comprising:
a memory; and
a processor coupled to the memory and configured to:
control the plurality of network switches so that one or more data flows pass through the first communication path,
monitor a load of the control device,
detect that a failure occurs in the first communication path, and
determine, based on a number of the one or more data flows and the load of the control device, a path selecting method of selecting the second communication path as an alternative communication path through which the data flows are to be transmitted.

2. The control device according to claim 1, wherein
the path selecting method includes a first method and a second method,
a first load of the control device in the first method is lower than a second load of the control device in the second method,
a first time taken to perform the first method is longer than a second time taken to perform the second method, and
the processor is configured to select at least one of the first method and the second method, based on the number of the data flows passing through the first communication path and the load of the control device.

3. The control device according to claim 2, wherein
the first method includes deleting first flow entries of the data flows from the network switches in the first communication path, and assigning a second flow entries of the data flows on the network switches in the second communication path when the first flow entries are deleted, and
the second method includes deleting the first flow entries of the data flows from the network switches in the first communication path, and assigning a second flow entries of the data flows on the network switches in the second communication path when the control device receive a message indicating an unknown data flow is inputted into a network switch on the first communication path.

4. The control device according to claim 3, wherein
the processor is configured to determine, based on information indicating a relationship between the number of the data flows and the load of the control device, a variation amount of the load of the control device caused by setting of the second communication path.

5. The control device according to claim 4, wherein
the processor is configured to:
select the second method when the load not including the variation amount is greater than or equal to a first threshold value, and
select the first method when the load including the variation amount is less than or equal to the first threshold value.

6. The control device according to claim 5, wherein
the processor is configured to select the second method for the data flows that correspond to a portion, in which the load exceeds the first threshold value, and to select the first method for the data flows that correspond to a portion, in which the load does not exceed the first threshold value, when the load including the variation amount exceeds the first threshold value.

7. The control device according to claim 5, wherein
the processor is configured to select the second method for all the data flows when the load including the variation amount exceeds the first threshold value.

8. The control device according to claim 4, wherein
the variation amount includes a processing amount used for reception processing of the message.

9. The control device according to claim 3, wherein
the processor is configured to limit, when the number of the data flows to be deleted is greater than or equal to a second threshold value in the first method, the network switches on which the deletion is to be implemented, to a starting-point network switch corresponding to a starting point of the data flows passing through the first communication path.

10. The control device according to claim 9, wherein
the processor is configured to execute, in addition to the starting-point network switch, deletion of the flow entries on the network switches located in stages subsequent to the starting-point network switch in the first communication path, when a processing load of the starting-point network switch becomes greater than or equal to a third threshold value in response to the deletion of the flow entries in the starting-point network switch.

11. The control device according to claim 2, wherein
the processor is configured to select, based on statistical information related to a traffic amount of the data flows passing through the first communication path, a first data flow, for which the second communication path is to be preferentially set, from among the one or more data flows in the first method.

12. The control device according to claim 1, wherein
the network switches are open flow switches, and
the control device is an open flow controller.

13. A method of controlling a plurality of network switches provided in a plurality of communication paths including a first communication path and a second communication path, the method comprising:
controlling the plurality of network switches so that one or more data flows pass through the first communication path;
monitoring a load of the control device;
detecting that a failure occurs in the first communication path; and
determining, based on a number of the one or more data flows and the load of the control device, a path selecting method of selecting the second communication path as an alternative communication path through which the data flows are to be transmitted.

14. The method according to claim 13, wherein
the path selecting method includes a first method and a second method,
a first load of the control device in the first method is lower than a second load of the control device in the second method,
a first time taken to perform the first method is longer than a second time taken to perform the second method, and
the determining includes selecting at least one of the first method and the second method, based on the number of the data flows passing through the first communication path and the load of the control device.

15. The method according to claim 14, wherein
the first method includes deleting first flow entries of the data flows from the network switches in the first communication path, and assigning a second flow entries of the data flows on the network switches in the second communication path when the first flow entries are deleted, and
the second method includes deleting the first flow entries of the data flows from the network switches in the first communication path, and assigning a second flow entries of the data flows on the network switches in the second communication path when the control device receive a message indicating an unknown data flow is inputted into a network switch on the first communication path.

16. The method according to claim 15 further comprising:
determining, based on information indicating a relationship between the number of the data flows and the load of the control device, a variation amount of the load of the control device caused by setting of the second communication path.

17. The method according to claim 16, wherein
in the selecting, the second method is selected when the load not including the variation amount is greater than or equal to a first threshold value, and
in the selecting, the first method is selected when the load including the variation amount is less than or equal to the first threshold value.

18. The method according to claim 17, wherein
in the selecting, the second method is selected for the data flows that correspond to a portion, in which the load exceeds the first threshold value, and the first method is selected for the data flows that correspond to a portion, in which the load does not exceed the first threshold value, when the load including the variation amount exceeds the first threshold value.

19. The method according to claim 17, wherein
in the selecting, the second method is selected for all the data flows when the load including the variation amount exceeds the first threshold value.

20. The method according to claim 16, wherein
the variation amount includes a processing amount used for reception processing of the message.
